(19) United States
(12) Patent Application Publication
(10) Pub. No.: US 2021/0293325 A1
(43) Pub. Date: Sep. 23, 2021

(54) OIL RECOVERY MECHANISM OF POWER TRANSMISSION DEVICE

(71) Applicant: Honda Motor Co., Ltd., Tokyo (JP)

(72) Inventor: Shuhei TANAKA, Saitama (JP)

(73) Assignee: Honda Motor Co., Ltd., Tokyo (JP)

(21) Appl. No.: 17/190,394

(22) Filed: Mar. 3, 2021

(30) Foreign Application Priority Data
Mar. 19, 2020 (JP) 2020-048545

(51) Int. Cl. F16H 57/04

(52) U.S. Cl. CPC F16H 57/0423; F16H 57/045; F16H 57/0484; F16H 57/0483; F16H 57/0457

(57) ABSTRACT

Provided is an oil recovery mechanism of a power transmission device capable of always recovering oil into an oil tank regardless of forward or reverse rotation of a rotating member. The oil recovery mechanism houses, in a case storing oil in a bottom part, a carrier (rotating member) rotating due to a drive force from an electric motor (drive source), and an oil tank having an opening open in a tangential direction on an upper part of an outer periphery of the carrier. The oil recovery mechanism scrapes up the oil by rotation of the carrier with a part immersed in the oil stored in the case to recover the oil into the oil tank. The opening of the oil tank includes a current straightening plate rotating due to a kinetic energy of the oil scraped up by the carrier to guide the oil to the oil tank.

### CROSS-REFERENCE TO RELATED APPLICATION

This application claims the priority benefit of Japan application serial no. 2020-048545, filed on Mar. 19, 2020. The entirety of the above-mentioned patent application is hereby incorporated by reference herein and made a part of this specification.

### BACKGROUND

### Technical Field

The disclosure relates to an oil recovery mechanism for recovering oil scraped up by rotation of a rotating member housed in a case of a power transmission device into an oil tank in the case.

### Description of Related Art

For example, a vehicle power transmission device houses rotating members such as various gears in a case, and an oil bath method may be adopted as a lubrication method, in which lubricating oil stored in the bottom part of the case is scraped up by the rotation of the rotating members, and the scraped-up oil lubricates each part. According to such an oil bath method, since a part of the rotating member is immersed in the oil stored in the bottom part of the case, the drag resistance (stirring resistance) due to the viscosity of the oil when the rotating member scrapes up the oil increases, which causes an increase in the power loss of the drive source.

Therefore, an oil tank for recovering oil is provided in the case, and a configuration is adopted in which an opening of the oil tank opens in the tangential direction (the direction in which the oil scraped up by the rotating member scatters) on the upper part of the outer periphery of the rotating member (See, for example, Patent Documents 1 and 2). According to such a configuration, the oil scraped up by the rotation of the rotating member flies in the tangential direction from the upper part of the outer periphery of the rotating member, is guided to the opening of the oil tank, and is recovered into the oil tank. Therefore, the amount of oil at the bottom part of the case is reduced (the oil level is lowered), the drag resistance of the oil due to the rotating member is suppressed to a small value, and the power loss of the drive source is also suppressed to a small value.

### RELATED ART

### Patent Document

[Patent Document 1] Japanese Laid-open No. 2005-008143

[Patent Document 2] Japanese Laid-open No. 2015-209916

However, in the oil recovery mechanism proposed in Patent Documents 1 and 2, there is a problem that the oil can be recovered into the oil tank only when the rotating member rotates in one direction (forward rotation), and the oil cannot be recovered into the oil tank when the rotating member rotates in the other direction (reverse rotation).

The disclosure has been made in view of the above problems, and the disclosure provides an oil recovery mechanism of a power transmission device capable of always recovering oil into an oil tank regardless of forward rotation or reverse rotation of a rotating member.

### SUMMARY

In order to achieve the above, the disclosure provides an oil recovery mechanism of a power transmission device (PT), which houses, in a case (1) that stores oil in a bottom part, a rotating member (c1) that rotates due to a drive force from a drive source (M), and an oil tank (8) that has an opening (8a) that opens in a tangential direction on an upper part of an outer periphery of the rotating member (c1), and which scrapes up the oil by rotation of the rotating member (c1) that has a part immersed in the oil stored in the bottom part of the case (1) to recover the oil into the oil tank (8). The opening (8a) of the oil tank (8) is provided with a current straightening plate (10) that rotates due to a kinetic energy of the oil guided to the opening (8a) to guide the oil to the opening (8a).

### BRIEF DESCRIPTION OF THE DRAWINGS

FIG. 1 is a cross-sectional view of an electric unit.

FIG. 2 is a cross-sectional view taken along the line A-A in FIG. 1.

FIG. 3 is an enlarged perspective view of the part B in FIG. 2.

FIG. 4 is a view similar to FIG. 2 and shows the flow of oil during the forward rotation of the rotating member.

FIG. 5 is an enlarged detailed view of the part C in FIG. 4.

FIG. 6 is a view similar to FIG. 2 and shows the flow of oil during the reverse rotation of the rotating member.

FIG. 7 is an enlarged detailed view of the part D in FIG. 6.

FIG. 8 is a cross-sectional view taken along the line E-E in FIG. 1.

### DESCRIPTION OF THE EMBODIMENTS

Here, it is desirable that the current straightening plate (10) is rotatably and axially supported in the case (1) with one end as a center, and is rotated due to the kinetic energy of the oil that is scraped up during forward rotation and reverse rotation of the rotating member (c1) to guide the oil to the oil tank (8).

According to the disclosure, at both the forward rotation and the reverse rotation of the rotating member, the oil scraped up by the rotating member collides with the current straightening plate, and the kinetic energy (pressing pressure) causes the current straightening plate to rotate to guide the oil to the oil tank, so a part of the oil scraped up by the rotating member is recovered into the oil tank. Therefore, the oil in the bottom part of the case is reduced (the oil level is lowered) regardless of the rotation direction of the rotating member, and the drag resistance of the oil due to the rotating member is suppressed to a small value, and the power loss of the drive source is also suppressed to a small value.

Further, it is desirable that a width (b) of the current straightening plate (10) is set to be equal to a width of the rotating member (c1).

For example, if the width of the current straightening plate is too narrow with respect to the width of the rotating member, the oil cannot be efficiently guided to the oil tank by the current straightening plate and cannot be recovered sufficiently, and conversely, if the width is too wide, the weight of the current straightening plate becomes large, and the rotation becomes insufficient, and the oil can be sufficiently guided to the oil tank only in one of the forward rotation and the reverse rotation of the rotating member. Therefore, by setting the width of the current straightening plate to be equal to the width of the rotating member, the current straightening plate rotates and guides the oil to the oil tank at both the forward rotation and the reverse rotation of the rotating member, so a necessary and sufficient amount of oil is recovered into the oil tank.

According to the disclosure, there is an effect that oil can always be recovered into the oil tank regardless of the forward rotation or reverse rotation of the rotating member.

Hereinafter, embodiments of the disclosure will be described with reference to the accompanying drawings.

[Configuration of Electric Unit]

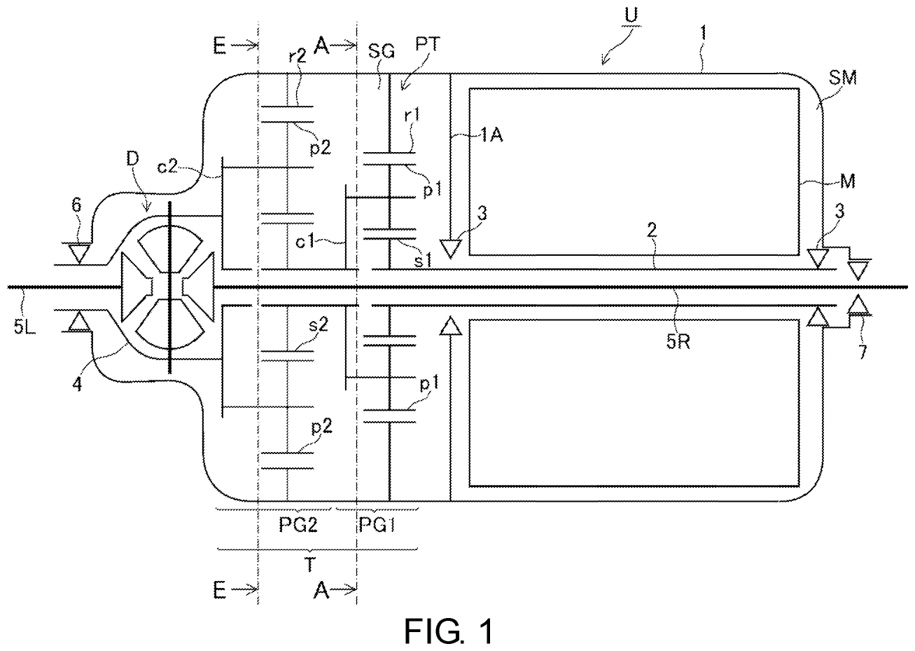

FIG. 1 is a cross-sectional view of an electric unit, and the shown electric unit U is mounted on an electric vehicle (EV vehicle) (not shown) and is configured as follows.

That is, the electric unit U shown in FIG. 1 is configured as a unit by housing, in a case 1, an electric motor M as a drive source and a power transmission device PT including an oil recovery mechanism according to the disclosure. Here, the power transmission device PT is configured by housing a multi-stage speed reducer T, a differential mechanism D, and the like. More specifically, the inside of the case 1 is divided into a motor chamber SM and a gear chamber SG by a partition wall 1A, and the electric motor M which is the drive source is housed in the motor chamber SM, and the gear chamber SG houses the multi-stage speed reducer T and the differential mechanism D. In addition, the electric motor M also functions as a generator during regeneration, and a battery is electrically connected to the electric motor M via an inverter (not shown), and the electric motor M is rotationally driven by the power supplied from the battery.

A rotatable hollow input shaft (motor shaft) 2 rotationally driven by the electric motor M is inserted through the center of the electric motor M, and both axial-direction (horizontal direction in FIG. 1) ends of the input shaft 2 are rotatably supported in the case 1 by bearings 3. One of the axial-direction ends (left end in FIG. 1) of the input shaft 2 penetrates the partition wall 1A of the case 1 and faces the gear chamber SG.

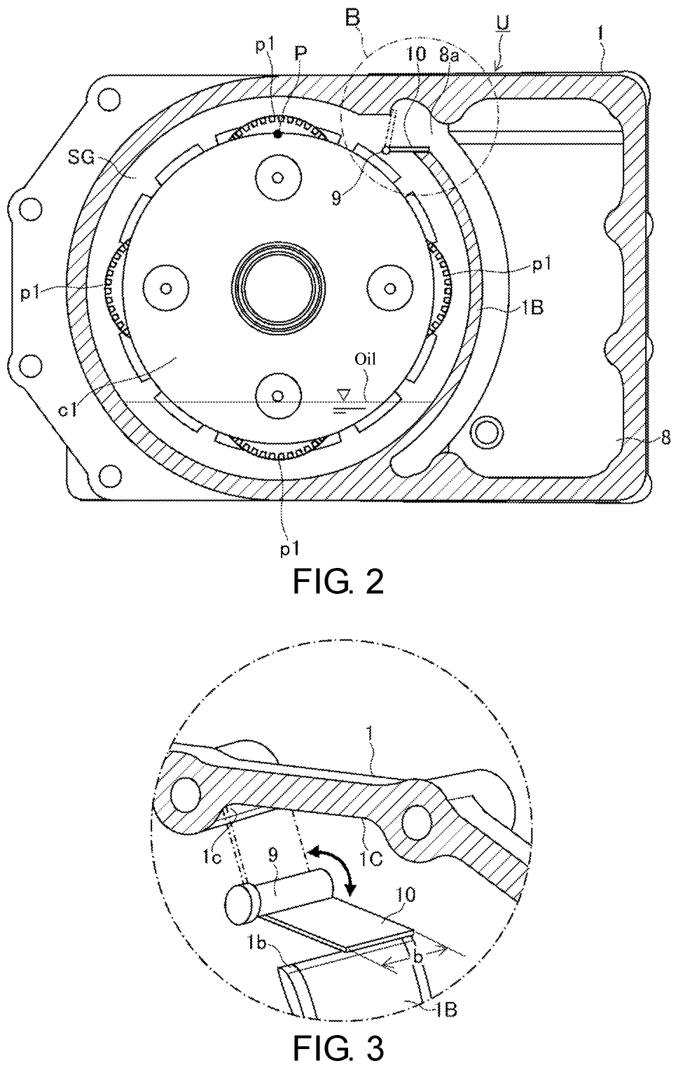

The multi-stage speed reducer T housed in the gear chamber SG includes a first planetary gear mechanism PG1 and a second planetary gear mechanism PG2 disposed side by side adjacent in the axial direction of the input shaft 2 (the left-right direction in FIG. 1). Here, the first planetary gear mechanism PG1 includes a small-diameter sun gear s1 formed on the outer periphery of one axial-direction end (left end in FIG. 1) of the input shaft 2 extending to the gear chamber SG, a large-diameter ring gear r1 fixed to the inner periphery of the case 1, multiple pinion gears (planetary gears) p1 (four pinion gears in this embodiment; see FIG. 2) which revolve around the sun gear s1 while rotating on their own axes and engaging with the sun gear s1 and the ring gear r1, and a carrier c1 which supports the pinion gears p1 rotatably (rotatably on their own axes).

Further, the second planetary gear mechanism PG2 includes a small-diameter sun gear s2 connected to the carrier c1 of the first planetary gear mechanism PG1, a large-diameter ring gear r2 fixed to the inner periphery of the case 1, multiple pinion gears (planetary gears) p2 (four pinion gears in this embodiment) which revolve around the sun gear s2 while rotating on their own axes and engaging with the sun gear s2 and the ring gear r2, and a carrier c2 which supports the pinion gears p2 rotatably (rotatably on their own axes).

In addition, a case (differential case) 4 of the differential mechanism D is connected to the carrier c2 of the second planetary gear mechanism PG2. Further, since the configuration of the differential mechanism D is known, the description thereof will be omitted; however, from this differential mechanism D, left and right output shafts (axles) 5L and 5R extend on the same axis along the vehicle width direction (left-right direction in FIG. 1), and wheels (drive wheels) (not shown) are attached to the outer ends of the axles 5L and 5R, respectively. Here, the case (differential case) 4 of the differential mechanism D is rotatably supported in the case 1 by bearings 6.

In addition, one output shaft (axle) 5R (on the right side of FIG. 1) penetrates the hollow part of the carrier c2 of the second planetary gear mechanism PG2 and the hollow input shaft (motor shaft) 2 and extends to the outside of the case 1, and the output shaft (axle) 5R and the input shaft (motor shaft) 2 are rotatably disposed on the same axis along the vehicle width direction. Further, an axial-direction end (right end in FIG. 1) of the output shaft (axle) 5R is rotatably supported in the case 1 by bearings 7.

Thus, in the electric unit U configured as described above, when the electric motor M is started and the input shaft (motor shaft) 2 is rotationally driven at a predetermined speed, the rotation of the input shaft 2 is decelerated in two stages by the first planetary gear mechanism PG1 and the second planetary gear mechanism PG2 and transmitted to the left and right output shafts (axles) 5L and 5R.

That is, in the first planetary gear mechanism PG1, when the sun gear s1 formed on the input shaft (motor shaft) 2 is rotationally driven together with the input shaft 2, the carrier c1 that supports the pinion gears p1, which revolve around the sun gear s1 while rotating on their own axes, rotates. As a result, the rotation of the input shaft (motor shaft) 2 is decelerated by the first planetary gear mechanism PG1 and transmitted to the carrier c1.

Then, in the second planetary gear mechanism PG2, the sun gear s2 formed on the carrier c1 of the first planetary gear mechanism PG1 rotates at the same speed as the carrier c1, and the carrier c2 that supports the pinion gears p2, which revolve around the sun gear s2 while rotating on their own axes, rotates at a decelerated speed (revolution speed of the pinion gears p2).

As a result of the above, the rotation of the input shaft (motor shaft) 2 is decelerated in two stages by the first planetary gear mechanism PGI and the second planetary gear mechanism PG2. Then, the case (differential case) 4 of the differential mechanism D rotates together with the carrier c2 of the second planetary gear mechanism PG2, and this rotation is distributed by the differential mechanism D and transmitted to the left and right output shafts (axles) 5L and 5R, and the left and right output shafts (axles) 5L and 5R are rotationally driven, respectively. As a result, the left and right wheels (drive wheels) (not shown) respectively attached to the outer ends of the left and right output shafts (axles) 5L and 5R are rotationally driven, so the electric vehicle (EV vehicle) travels at a predetermined speed.

[Oil Recovery Mechanism]

Next, an oil recovery mechanism according to the disclosure will be described below with reference to FIGS. 2 to 8.

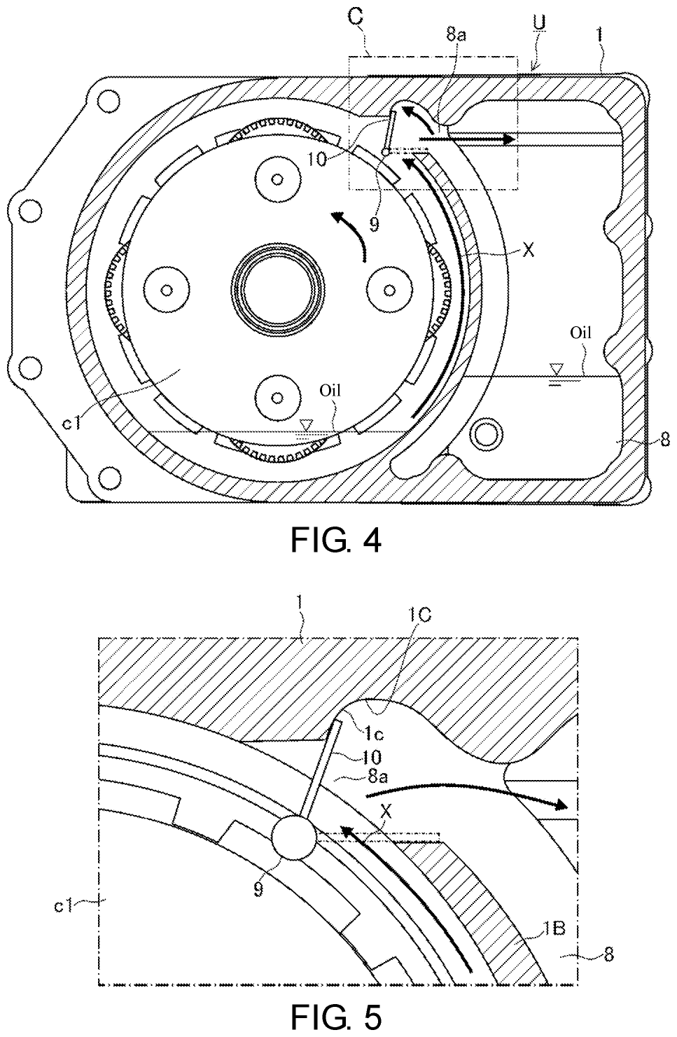

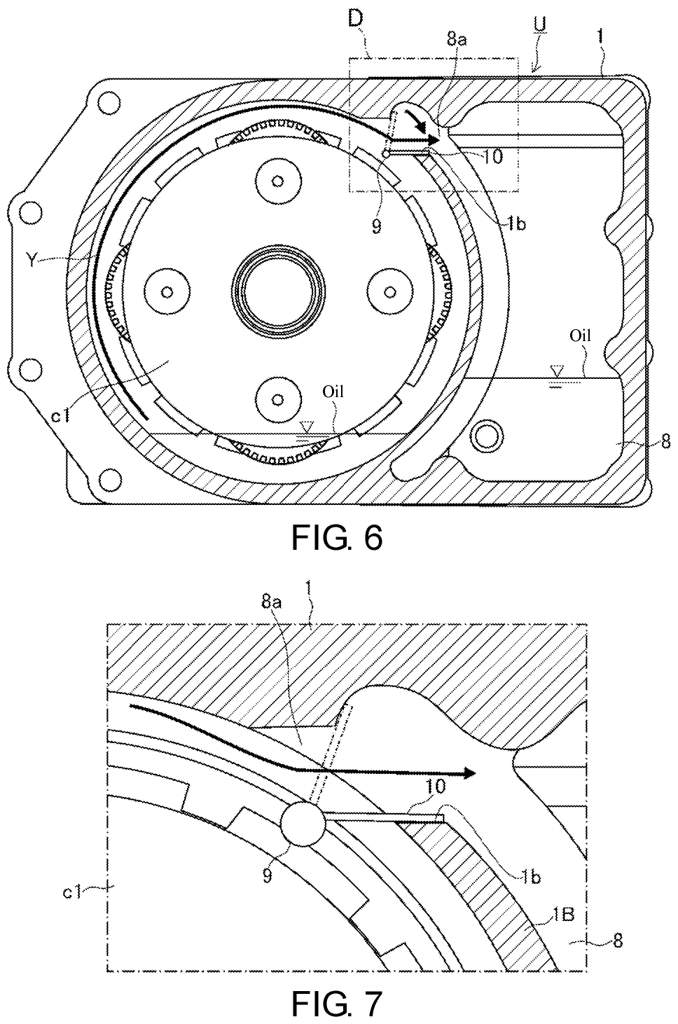

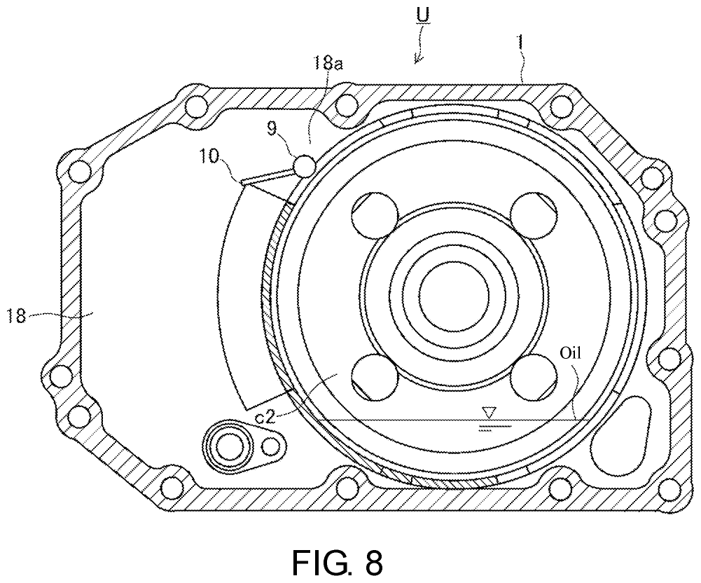

FIG. 2 is a cross-sectional view taken along the line A-A in FIG. 1. FIG. 3 is an enlarged perspective view of the part B in FIG. 2. FIG. 4 is a view similar to FIG. 2 and shows the flow of oil during the forward rotation of the rotating member. FIG. 5 is an enlarged detailed view of the part C in FIG. 4. FIG. 6 is a view similar to FIG. 2 and shows the flow of oil during the reverse rotation of the rotating member. FIG. 7 is an enlarged detailed view of the part D in FIG. 6. FIG. 8 is a cross-sectional view taken along the line E-E in FIG. 1.

As shown in FIG. 2, lubricating oil is stored in the bottom part of the case 1, and an oil tank 8 for recovering the oil is integrally formed on a side part (right part in FIG. 2) of a part of the case 1 in which the first planetary gear mechanism PGI is housed. Here, a part of the carrier c1 which configures a rotating member of the first planetary gear mechanism PGI is immersed in the oil stored in the bottom part of the case 1, and an opening 8a of the oil tank 8 opens in the tangential direction passing through the upper part of the outer periphery (point P) of the carrier c1. That is, the opening 8a of the oil tank 8 is formed in the direction (left-right direction in FIG. 2) perpendicular to the axis at the upper part of the oil tank 8 and opens toward the carrier cl which is the rotating member.

Then, as shown in detail in FIG. 3, the opening 8a of the oil tank 8 is provided with a rectangular plate-shaped current straightening plate 10 with an end rotatably and axially supported by a shaft 9 in the case 1. As will be described later, the current straightening plate 10 achieves a function of selectively rotating in the directions of the arrow in FIG. 3 by the kinetic energy of the oil (pressing pressure when the oil collides with the current straightening plate 10) scraped up by the forward and reverse rotation of the carrier c1 which is the rotating member, and guiding the oil to the opening 8a of the oil tank 8. Here, the width b of the current straightening plate 10 (see FIG. 3) is set to a value equal to the width of the carrier c1 which is the rotating member.

Next, the operation of the oil recovery mechanism configured as described above will be described below.

That is, during the forward rotation when the carrier c1 which is the rotating member rotates in the direction of the arrow in FIG. 4 (counterclockwise direction), the oil stored in the bottom part of the case 1 is scraped up by the carrier c1 along the inner peripheral wall of the case 1 in the rotation direction of the carrier c1 (the direction of the arrow X in FIG. 4 (counterclockwise direction)). A part of this scraped-up oil is used for lubrication and cooling of each part (particularly each sliding part) in the case 1, and other remaining oil is guided to the oil tank 8 by the current straightening plate 10 and recovered into the oil tank 8 as described below.

That is, the oil that is scraped up by the carrier c1 and flows in the direction of the arrow X along the inner peripheral wall of the case 1 collides with the current straightening plate 10 which is in contact with an end 1b of a rib 1B of the case 1 as shown by the chain line in FIG. 5, and the collision force (kinetic energy) causes the current straightening plate 10 to rotate about the shaft 9 in the direction of the arrow (counterclockwise direction). Then, the current straightening plate 10 comes into contact with an inner end wall 1c of a recess 1C of the case 1 and stops, and guides the scraped-up oil to the opening 8a of the oil tank 8. Therefore, during the forward rotation of the carrier c1, a part of the oil scraped up by the carrier c1 is recovered into the oil tank 8. As a result, the amount of oil stored in the bottom part of the case 1 is reduced (the oil level is lowered), and the drag resistance (stirring resistance) of the oil due to the carrier c1 is suppressed to a small value, and the power loss of the electric motor M (see FIG. 1) during the forward rotation of the carrier c1 is also suppressed to a small value.

On the other hand, during the reverse rotation when the carrier cl rotates in the direction of the arrow in FIG. 6 (clockwise direction), the oil stored in the bottom part of the case 1 is scraped up by the carrier c1 along the rotation direction of the carrier c1 (the direction of the arrow Y in FIG. 6 (clockwise direction)). A part of this scraped-up oil is used for lubrication and cooling of each part (particularly each sliding part) in the case 1, and other remaining oil is guided to the oil tank 8 by the current straightening plate 10 and recovered into the oil tank 8 as described below.

That is, the oil that is scraped up by the carrier c1 and flows in the direction of the arrow Y along the inner peripheral wall of the case 1 collides with the current straightening plate 10 which is in contact with the inner end wall 1c of the recess 1C of the case 1 as shown by the chain lines in FIG. 6 and FIG. 7, and the collision force (kinetic energy) causes the current straightening plate 10 to rotate about the shaft 9 in the direction of the arrow (clockwise direction). Then, the current straightening plate 10 comes into contact with the end 1b of the rib 1B of the case 1 and stops, and guides the scraped-up oil to the opening 8a of the oil tank 8. Therefore, during the reverse rotation of the carrier c1, a part of the oil scraped up by the carrier c1 is recovered into the oil tank 8. As a result, the amount of oil stored in the bottom part of the case 1 is reduced (the oil level is lowered), and the drag resistance (stirring resistance) of the oil due to the carrier c1 is suppressed to a small value, and the power loss of the electric motor M (see FIG. 1) during the reverse rotation of the carrier cl is also suppressed to a small value.

As described above, according to the oil recovery mechanism according to the disclosure, at both the forward rotation and the reverse rotation of the carrier c1 which is the rotating member, the oil scraped up by the carrier c1 collides with the current straightening plate 10, and the kinetic energy (pressing pressure) causes the current straightening plate 10 to rotate to guide the oil to the opening 8a of the oil tank 8, so the oil is recovered into the oil tank 8. Therefore, the oil in the bottom part of the case 1 is reduced (the oil level is lowered) regardless of the rotation direction of the carrier cl, and the drag resistance of the oil due to the carrier cl is suppressed to a small value, and the power loss of the electric motor M which is the drive source is also suppressed to a small value.

In addition, if the width b of the current straightening plate 10 (see FIG. 3) is too narrow with respect to the width of the carrier c1, the oil cannot be efficiently guided to the oil tank 8 and cannot be recovered sufficiently, and conversely, if the width b is too wide, the weight of the current straightening plate 10 becomes large, and the rotation becomes insufficient, and the oil can be sufficiently guided to the oil tank 8 only in one of the forward rotation and the reverse rotation of the carrier c1.

Therefore, in the embodiment, the width b of the current straightening plate 10 (see FIG. 3) is set to be equal to the width of the carrier c1 as described above. Therefore, the current straightening plate 10 rotates and guides the oil to the opening 8a of the oil tank 8 at both the forward rotation and the reverse rotation of the carrier c1, so a necessary and sufficient amount of oil is recovered into the oil tank 8.

Further, in the electric unit U according to the embodiment, as shown in FIG. 8, an oil tank 18 is also formed at a position corresponding to the carrier c2 of the second planetary gear mechanism PG2 of the case 1, and an opening 18a that opens in the tangential direction passing through the upper part of the outer periphery of the carrier c2 is formed in the upper part of the oil tank 18. Then, the opening 18a is provided with the current straightening plate 10 with one end rotatably and axially supported by the shaft 9 in the case 1.

Thus, during the forward and reverse rotation of the carrier c2 which is the rotating member, the kinetic energy (pressing pressure) of the oil scraped up by the carrier c2 causes the current straightening plate 10 to rotate about the shaft 9 to guide the oil to the opening 18a of the oil tank 18. Therefore, a part of the oil is guided to the opening 18a of the oil tank 18 by the current straightening plate 10 and recovered into the oil tank 18.

Therefore, the oil in the bottom part of the case 1 is reduced (the oil level is lowered) regardless of the rotation direction of the carrier c2 which is the rotating member, and the drag resistance of the oil due to the carrier c2 is suppressed to a small value, and the power loss of the electric motor M is also suppressed to a small value.

Here, since the width of the current straightening plate 10 is set to be equal to the width of the carrier c2, the current straightening plate 10 functions normally for the same reason as described above, and the necessary and sufficient oil is recovered into the oil tank 18. Further, in the above description, the carrier c1 of the first planetary gear mechanism PG1 and the carrier c2 of the second planetary gear mechanism PG2 have been described as examples of the rotating member that scrapes up the oil stored in the bottom part of the case 1, but the rotating member may be another member such as a gear immersed in oil.

Further, the disclosure is not limited to the embodiments described above, and various modifications can be made within the scope of claims and the technical ideas described in the specification and drawings.

What is claimed is:

1. An oil recovery mechanism of a power transmission device, which houses, in a case that stores oil in a bottom part, a rotating member that rotates due to a drive force from a drive source, and an oil tank that has an opening that opens in a tangential direction on an upper part of an outer periphery of the rotating member, and which scrapes up the oil by rotation of the rotating member that has a part immersed in the oil stored in the bottom part of the case to recover the oil into the oil tank,
wherein the opening of the oil tank is provided with a current straightening plate that rotates due to a kinetic energy of the oil guided to the opening to guide the oil to the opening.

2. The oil recovery mechanism of the power transmission device according to claim 1, wherein the current straightening plate is rotatably and axially supported in the case with one end as a center, and is rotated due to the kinetic energy of the oil that is scraped up during forward rotation and reverse rotation of the rotating member to guide the oil to the oil tank.

3. The oil recovery mechanism of the power transmission device according to claim 1, wherein a width of the current straightening plate is set to be equal to a width of the rotating member.

4. The oil recovery mechanism of the power transmission device according to claim 2, wherein a width of the current straightening plate is set to be equal to a width of the rotating member.
